(19) United States
(12) Patent Application Publication
(10) Pub. No.: US 2023/0319547 A1
(43) Pub. Date: Oct. 5, 2023

(54) DEVICE IDENTIFICATION FOR NEWLY CONNECTING DEVICES USING MAC RANDOMIZATION ON A NETWORK

(71) Applicant: Fortinet, Inc., Sunnyvale, CA (US)

(72) Inventor: Haitao Li, Coquitlam (CA)

(21) Appl. No.: 17/710,208

(22) Filed: Mar. 31, 2022

(51) Int. Cl. H04W 12/02; G16Y 30/10; H04L 9/40

(52) U.S. Cl. CPC H04W 12/02; G16Y 30/10; H04L 63/20

(57) ABSTRACT

In identification training, database of known devices is used to identify unlabeled clusters from statistics concerning parameters, vendors and hostnames of the known devices. Relevant clusters of type, brand and model from are identified from the unlabeled clusters using a threshold and labeling the relevant clusters with a key including type, brand and model of the labeled clusters. In real-time identification, a real time connection of a new device, a type, brand and model of the new device is determined using the parameters, vendors and hostnames and to compare against the keys for identifying the new device.

### FIELD OF THE INVENTION

The invention relates generally to computer networking, and more specifically, for identifying new devices connecting to a Wi-Fi network using randomized MAC addresses.

### BACKGROUND

Wireless Internet-of-Things (IoT) devices are known to be the source of many security problems, and as such, they would greatly benefit from automated management. This requires robustly identifying devices so that appropriate network security policies can be applied. Authentic media access control (MAC) address is used by conventional methods to identity type, brand and model of a device. A MAC is a unique identifier assigned to a network interface controller (NIC) for use as a network address in communications within a network segment. This use is common in most IEEE 802 networking technologies, including Ethernet, Wi-Fi, and Bluetooth.

MAC addresses can be used to help identify a device. First, devices of popular brands like Samsung, Apple, Huawei usually use their own MAC address assigned by IEEE. From this information, possible types/brands of the device can be inferred. Moreover, many device producers assign consecutive MAC addresses to the same type of its devices. Thus, MAC ranges can be formulated to identify those devices.

However, major system providers have recently introduced MAC randomization to prevent listeners from using MAC addresses to build a history of device activity, thus increasing user privacy. For example, iOS 14, iPadOS 14, and watchOS 7 introduce a new Wi-Fi privacy feature: When an iPhone, iPad, iPod touch, or Apple Watch connects to a Wi-Fi network, it identifies itself with a unique (random) MAC address per network. These setting are by default. In Android 10, MAC randomization is enabled by default for client mode, SoftAp, and Wi-Fi Direct. Some versions of Windows 10 have a feature that randomizes the MAC address for different Wi-Fi connections.

Although it helps in privacy protection, MAC randomization also poses challenge to device recognition and management. The conventional identification methods become weak or fail in the environment of devices with randomly generated fake MAC address that have little or no correspondence to device identification.

Therefore, what is needed is a robust technique for identifying new devices connecting to a Wi-Fi network using randomized MAC addresses.

### SUMMARY

These shortcomings are addressed by the present disclosure of methods, computer program products, and systems for identifying new devices connecting to the enterprise network using randomized MAC addresses.

In one embodiment, in an identification training phase, a database of known devices is used to identify unlabeled clusters from statistics concerning parameters, vendors and hostnames of the known devices.

In other embodiments, relevant clusters of type, brand and model from are identified from the unlabeled clusters using a threshold and labeling the relevant clusters with a key including type, brand and model of the labeled clusters. As a result, a predictive clustering model has been generated.

In another embodiment, in a real time identification phase, a connection of a new device, a type, brand and model of the new device is determined using the parameters, vendors and hostnames and to compare against the keys for identifying the new device. The real MAC address is not needed for identification.

Advantageously, network performance is improved with uniform security policy application. Computer device performance is also improved by reducing malicious network traffic for processing.

### BRIEF DESCRIPTION OF THE DRAWINGS

In the following drawings, like reference numbers are used to refer to like elements. Although the following figures depict various examples of the invention, the invention is not limited to the examples depicted in the figures.

FIG. 1 is a block diagram illustrating a system for identifying new devices connecting to the enterprise network using randomized MAC addresses, according to an embodiment.

FIG. 2 is a more detailed block diagram illustrating a device identification server of the system of FIG. 1, according to an embodiment.

FIG. 3A is a sequence diagram illustrating new device identification, according to an embodiment.

FIG. 3B is a sample source code listing for generating clusters from known labeled devices, according to an embodiment.

FIG. 3C is a sample source code listing for labeling of the generated clusters of FIG. 3B, according to an embodiment.

FIG. 4 is a high-level flow diagram illustrating a method for identifying new devices connecting to the enterprise network using randomized MAC addresses, according to one preferred embodiment.

FIG. 5 is a more detailed flow diagram illustrating a step of training cluster prediction with known labeled devices, for the method of FIG. 4, according to one embodiment.

FIG. 6 is a high-level block diagram illustrating a computing device as an example hardware implementation of network devices herein, according to an embodiment.

### DETAILED DESCRIPTION

The description below provides methods, computer program products, and systems for identifying new devices connecting to the enterprise network using randomized MAC addresses to substitute actual MAC addresses.

One of ordinary skill in the art will recognize many additional variations made possible by the succinct description of techniques below.

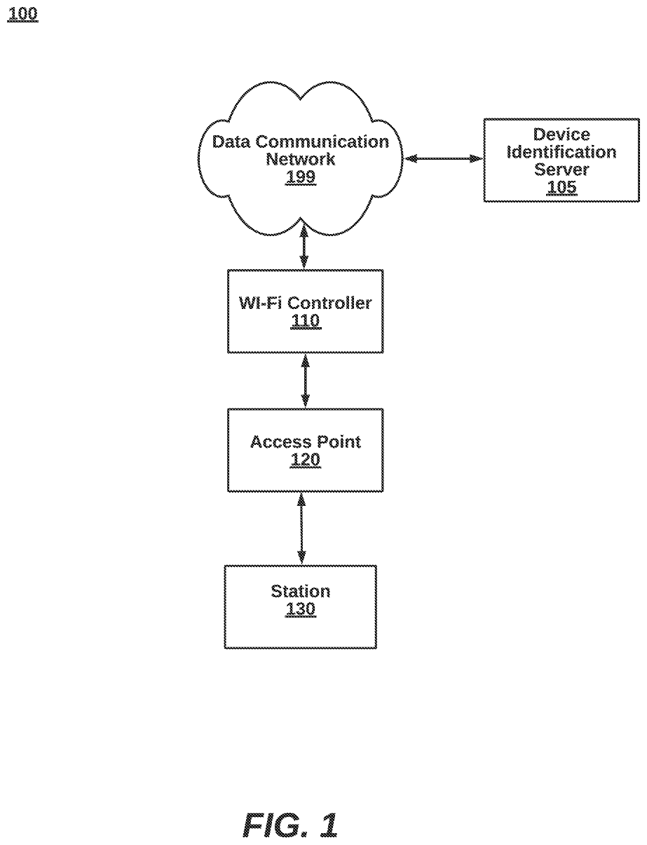

I. Systems for Randomized MAC Device Identification (FIGS. 1-3)

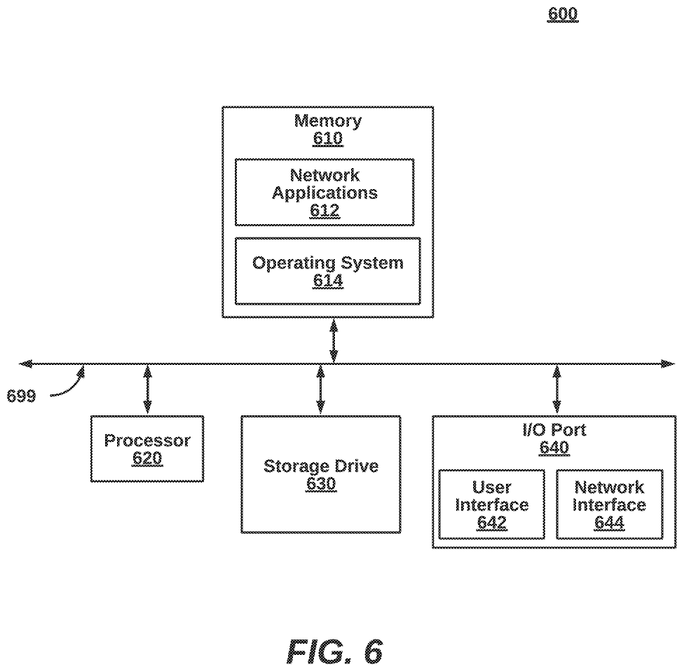

FIG. 1 is a block diagram illustrating a system 100 for identifying new devices connecting to the enterprise network using randomized MAC addresses to cover an actual MAC address, according to an embodiment. The system 100 includes a device identification server 105, a Wi-Fi controller 110, an access point 120 and a station 130, coupled to a data communication network 199. Many other configurations are possible, for example, with additional network components such routers, switches, repeaters, firewalls, and the like. Also, there can be many more or fewer clients in FIG. 1. The system components can be implemented in computer devices with non-transitory source code, such as set forth below with reference to FIG. 6.

The components of the system 100 are coupled in communication over the data communication network. The components can be connected to the data communication system via hard wire. The data communication network 199 can be any data communication network such as an SDWAN, an SDN (Software Defined Network), WAN, a LAN, WLAN, a cellular network (e.g., 3G, 4G, 5G or 6G), or a hybrid of different types of networks. Various data protocols can dictate format for the data packets. For example, Wi-Fi data packets can be formatted according to IEEE 802.11, IEEE 802.11r, and the like including IPv4, IPv6, or other protocols.

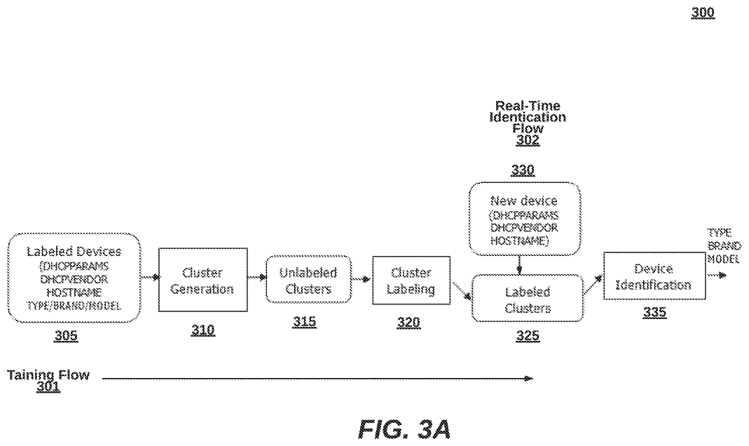

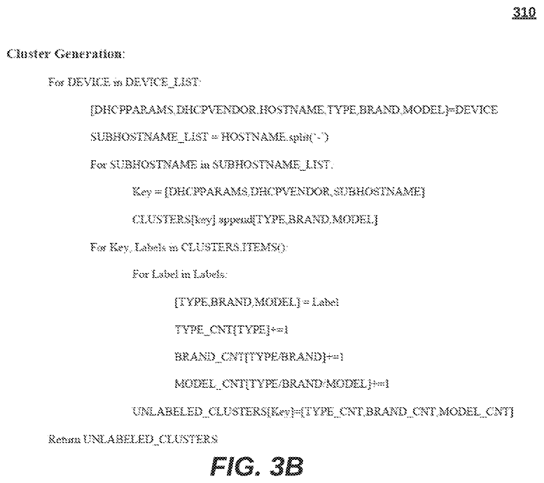

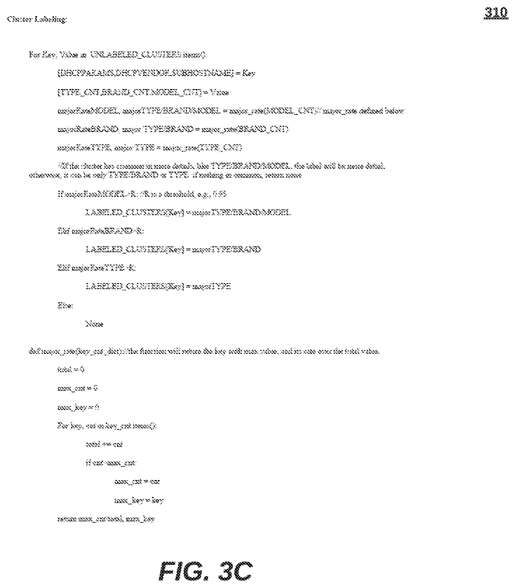

In a training flow 301 of the system 100 before real-time operation, as shown in FIG. 3A, a labeled devices database 305 is processed for cluster generation 310 of unlabeled clusters 315. Cluster labeling 320 is applied to generate labeled clusters 325. Many different clustering statistical models can be implemented. In a separate, real-time flow 302 of the system 100, a new device DHCP information 330 uses the labeled clusters 325 to identification (or statistically predict) a device 335, including type, brand and model for security policy application and other purposes.

Unlike conventional device identification methods, MAC address is not necessary to identify a device type and brand. Instead, it mainly uses the Dynamic Host Configuration Protocol (DHCP). DHCP is a network management protocol used on Internet Protocol (IP) networks for automatically assigning IP addresses and other communication parameters to devices connected to the network. More specifically, it mainly uses three DHCP Options: Option 55 (DHCP Parameters), Option 60 (DHCP Vendor), and Option 12 (Hostname). Such information will be not changed when a device connects to networks with random MACs.

The same DHCP Parameters and DHCP Vendor are usually shared among devices which install the same operating system, and they are used to quickly narrow the searching space. Hostname is more personal. Hostname can be parsed, and detections are made together with DHCP Parameters, and DHCP Vendor.

Although DHCP VENDOR, DHCP PARAMS or HOSTNAME are good indicators for identifying devices, they may not be individually used to identify the same cluster for most cases. For example, DHCP PARAMS (1,121,3,6,15,119,252) is wildly used by Apple's products such as iPhone, iPad, iWatch, and Apple TV. They don't have the same device type. DHCP VENDOR (android-dhcp-10) is wildly used by android devices. They don't have the same brands and types. Our solution is trying to find combinations of DHCP VENDOR, DHCP PARAMS, and HOSTNAME, which can identify clusters of the same devices.

And then it gives a device identification (Type, Brand, Model) for each cluster. The same device could be only the same type, or more details like the same type/brand and the same type/brand/model.

Comparing with DHCP VENDOR and PARAMS, HOSTNAME is usually more personal. For example, it can include some random chars like “Android-124fa3d4”. It may also include a user's name like “iPhone-Mike”. Generating combination by original HOSTNAME with DHCPVENDOR and DHCPPARAMS, the number of combinations will explode and we also miss some meaningful combinations. Valid characters for hostnames are ASCII (7) letters from a to z, the digits from 0 to 9, and the hyphen (-), and normally, hyphen (-) split a hostname to different meaningful parts. For example, Android-124fa3d4 will be [Android,124fa3d4], iPhone-Mike will be [iPhone, Mike]. “Android”, “iPhone” are common part shared by lots of similar devices, and “124fa3d4” and “Mike” are individual part.

Turning to the individual components of the system 100, the device identification server 105 predicts device types for newly connected devices with clustering. In an identification training phase, a database of labeled devices is processed to develop cluster prediction models. Subsequently, in a real-time identification phase, automatic IP address assignment through DHCP protocol, basic device info is extracted and compared with the clustering prediction models to determine the device type for security policy application. The clustering prediction model can be updated based on new connections by comparing predicted device identification to actual identification (e.g., through actual MAC discovery).

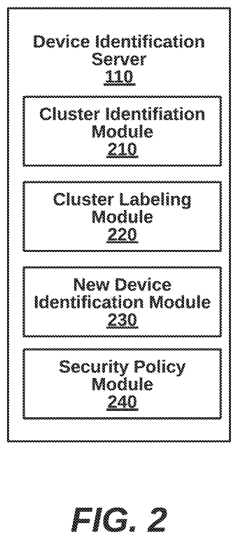

The device identification server 105 can be a separate server or a module integrated into a host server (e.g., an access point, a gateway, or a firewall) on a private network behind a firewall. Alternatively, the device identification server 105 can be a SaaS (software as a service) located on the cloud for serving multiple different private networks of the same entity (e.g., Starbucks at different locations) or different entities (e.g., different customers). Cloud-based implementations have access to a wider body of data for training. Local and remote servers can also cooperate real-time in device identification. Additional embodiments of the device identification server 105 are disclosed below with regard to FIG. 2.

The station 140 is a device identified by type, brand, and model with clustering. When negotiating an IP address with a randomized MAC address, information is sent to the DHCP server to formulate an IPv6 address on the network. The request includes parameters, vendors and hostnames embedded in headers of the request, such as option 55, 60, and 12. Option 55 contains a list of configuration parameters that a DHCP client is requesting. Option 60 contains a vendor class identifier that indicates the device type of the requesting client. Option 12 contains the Hostname of the requesting client. It is these characteristics that are utilized for identification by the device identification server 110 by clustering prediction.

Once identified, the station 140 can have certain default policies to be applied based on type, brand, and model. One embodiment of the station 140 has more than one network interface resulting in more than one MAC address, and more than one randomized MAC addresses. Additional identification information can be gleaned about the user and past connection histories of the user and/or device may be accessed.

The access point 120 connects the station 130 over a wireless channel to the backhaul network and the LAN, using a randomized MAC address for a network interface for connection to the wireless channel. Connections using real MAC addresses can also be processed and the results used to tune the prediction model. Many implementations apply security policies to the station 130 at the access point 120 to immediately suppress certain behaviors by the station 130. Network wide knowledge and processing power also protects the station 130 for incoming data traffic. Once the station 130 is identified, security policies can be applied based on one or more of type, brand, and model, along with other factors.

The Wi-Fi controller 110 uses information across multiple access points for device identification. One embodiment of the Wi-Fi controller 110 cooperates with the device identification server 110 in real-time device identifications. In standard operations, the Wi-Fi controller 110 manages the access point 120 and any others that connect, as well as manages and tracks the station 130 and any others that connect.

FIG. 2 is a more detailed block diagram illustrating an IPS module 110 of the file sharing system of FIG. 1, according to an embodiment. The opportunistic key engine 110 includes a cluster generation module 210, a cluster labeling module 220, a device identification module 230, and a security policy module 240. The modules can be implemented in source code stored in non-transitory memory executed by a processor. Alternatively, the modules can be implemented in hardware with microcode. The modules can be singular or representative of functionality spread over multiple components. Many other variations are possible.

The cluster generation module 210 for using a database of known devices to identify unlabeled clusters from statistics concerning parameters, vendors and hostnames of the known devices.

The cluster labeling module 220 to find relevant clusters of type, brand and model from the unlabeled clusters using a threshold and labeling the relevant clusters with a key including type, brand and model of the labeled clusters.

The device identification module 230 to determine for a real time connection of a new device, a type, brand and model of the new device using the parameters, vendors and hostnames and to compare against the keys for identifying the new device.

The security policy module 240 applies security rules based on one or more of type, brand and model of the station 130. DHCP information provides a cold start device identification. In some embodiments, device identification is updated or weighted against slower techniques such as traffic analysis. The security policy module 240 can include a database of default security rules organized by device types.

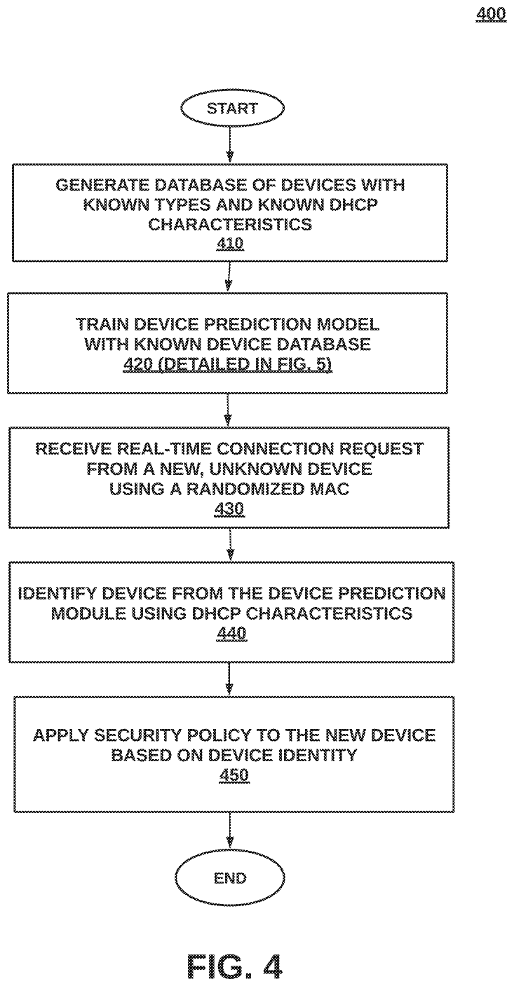

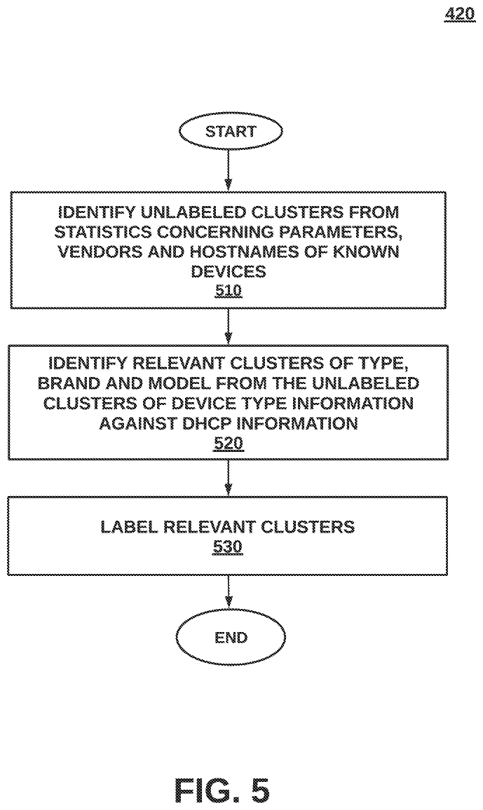

II. Methods for Randomized MAC Device Identification (FIGS. 4-5)

FIG. 4 is a high-level flow diagram illustrating a method for identifying new devices connecting to the enterprise network using randomized MAC addresses, according to an embodiment. The method 400 can be implemented, for example, by the system 100. The steps are merely representative groupings of functionality, as there can be more or fewer steps, and the steps can be performed in different orders. Many other variations of the method 400 are possible.

More detail concerning an example of the database training step is disclosed in FIG. 5. At step 510, a database of known devices is used to identify unlabeled clusters from statistics concerning parameters, vendors and hostnames of the known devices.

At step 520, relevant clusters of type, brand and model from are identified from the unlabeled clusters using a threshold and labeling the relevant clusters with a key including type, brand and model of the labeled clusters.

At step 530, in a real time connection of a new device, a type, brand and model of the new device is determined using the parameters, vendors and hostnames and to compare against the keys for identifying the new device.

III. Generic Computing Environment

FIG. 6 is a block diagram illustrating a computing device 600 capable of implementing components of the system, according to an embodiment. The computing device 600, of the present embodiment, includes a memory 610, a processor 620, a storage drive 630, and an I/O port 640. Each of the components is coupled for electronic communication via a bus 699. Communication can be digital and/or analog and use any suitable protocol. The computing device 600 can be any of components of the system 100 (e.g., device identification server 110, Wi-Fi controller 120, access point 130, and station 140), other networking devices (e.g., an access point, a firewall device, a gateway, a router, or a wireless station), or a disconnected device.

Network applications 612 (e.g., VM nodes 120A-F) can be network browsers, daemons communicating with other network devices, network protocol software, and the like. An operating system 614 within the computing device 600 executes software, processes. Standard components of the real OS environment 614 include an API module, a process list, a hardware information module, a firmware information module, and a file system. The operating system 614 can be FORTIOS, one of the Microsoft Windows® family of operating systems (e.g., Windows 96, 98, Me, Windows NT, Windows 2000, Windows XP, Windows XP x64 Edition, Windows Vista, Windows CE, Windows Mobile, Windows 6 or Windows 8), Linux, HP-UX, UNIX, Sun OS, Solaris, Mac OS X, Alpha OS, AIX, IRIX32, IRIX64, or Android. Other operating systems may be used. Microsoft Windows is a trademark of Microsoft Corporation.

The storage drive 630 can be any non-volatile type of storage such as a magnetic disc, EEPROM (electronically erasable programmable read-only memory), Flash, or the like. The storage drive 630 stores code and data for applications.

The I/O port 640 further comprises a user interface 642 and a network interface 644. The user interface 642 can output to a display device and receive input from, for example, a keyboard. The network interface 644 (e.g., an RF antennae) connects to a medium such as Ethernet or Wi-Fi for data input and output. Many of the functionalities described herein can be implemented with computer software, computer hardware, or a combination.

Computer software products (e.g., non-transitory computer products storing source code) may be written in any of various suitable programming languages, such as C, C++, C#, Oracle® Java, JavaScript, PHP, Python, Perl, Ruby, AJAX, and Adobe® Flash®. The computer software product may be an independent application with data input and data display modules. Alternatively, the computer software products may be classes that are instantiated as distributed objects. The computer software products may also be component software such as Java Beans (from Sun Microsystems) or Enterprise Java Beans (EJB from Sun Microsystems). Some embodiments can be implemented with artificial intelligence.

Furthermore, the computer that is running the previously mentioned computer software may be connected to a network and may interface with other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, and 802.11ac, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

The phrase “network appliance” generally refers to a specialized or dedicated device for use on a network in virtual or physical form. Some network appliances are implemented as general-purpose computers with appropriate software configured for the particular functions to be provided by the network appliance; others include custom hardware (e.g., one or more custom Application Specific Integrated Circuits (ASICs)). Examples of functionality that may be provided by a network appliance include, but is not limited to, layer 2/3 routing, content inspection, content filtering, firewall, traffic shaping, application control, Voice over Internet Protocol (VoIP) support, Virtual Private Networking (VPN), IP security (IPSec), Secure Sockets Layer (SSL), antivirus, intrusion detection, intrusion prevention, Web content filtering, spyware prevention and anti-spam. Examples of network appliances include, but are not limited to, network gateways and network security appliances (e.g., FORTIGATE family of network security appliances and FORTICARRIER family of consolidated security appliances), messaging security appliances (e.g., FORTIMAIL family of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTIWIFI family of wireless security gateways), FORIDDOS, wireless access point appliances (e.g., FORTIAP wireless access points), switches (e.g., FORTISWITCH family of switches) and IP-PBX phone system appliances (e.g., FORTIVOICE family of IP-PBX phone systems).

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

We claim:

1. A network device coupled to a data communication network and to an enterprise network, for identifying new devices connecting to the enterprise network using randomized MAC addresses, the network device comprising:
a processor;
a network interface communicatively coupled to the processor and communicatively coupled to exchange data packets over the data communication network; and
a memory communicatively coupled to the processor and storing:
a cluster generation module for using a database of known devices to identify unlabeled clusters from statistics concerning parameters, vendors and hostnames of the known devices of the known devices;
a cluster labeling module to find relevant clusters of mapped type, brand and model from the unlabeled clusters using a threshold and labeling the relevant clusters with a key including type, brand and model of the labeled clusters;
a device identification module to determine for a real time connection of a new device, a type, brand and model of the new device using the parameters, vendors and hostnames and to compare against the keys for identifying the new device; and
a security policy module to apply at least one security rule concerning at least one of the type, brand and model of the new device.

2. The network device of claim 1, wherein the device identification module intercepts a DHCP request.

3. The target access point of claim 1, wherein the device identification module uses long-term data traffic as a factor in an updated device identification.

4. A method in a network device communicatively coupled to a data communication network including a Wi-Fi network with a plurality of stations, for identifying new devices connecting to the enterprise network using randomized MAC addresses, the method comprising the steps of:
using a database of known devices to identify unlabeled clusters from statistics concerning parameters, vendors and hostnames of the known devices of the known devices;
identifying relevant clusters of mapped type, brand and model from the unlabeled clusters using a threshold and labeling the relevant clusters with a key including type, brand and model of the labeled clusters;
determining for a real-time connection of a new device, a type, brand and model of the new device using the parameters, vendors and hostnames and to compare against the keys for identifying the new device; and
applying at least one security rule concerning at least one of the type, brand and model of the new device.

5. A non-transitory computer-readable media in network device communicatively coupled to a data communication network including an Wi-Fi network with a plurality of stations, for identifying new devices connecting to the enterprise network using randomized MAC addresses controller, the method comprising the steps of:
using a database of known devices to identify unlabeled clusters from statistics concerning parameters, vendors and hostnames of the known devices of the known devices;
identifying relevant clusters of mapped type, brand and model from the unlabeled clusters using a threshold and labeling the relevant clusters with a key including type, brand and model of the labeled clusters;
determining for a real-time connection of a new device, a type, brand and model of the new device using the parameters, vendors and hostnames and to compare against the keys for identifying the new device; and
applying at least one security rule concerning at least one of the type, brand and model of the new device.
